(19) United States
(12) Patent Application Publication
(10) Pub. No.: US 2021/0268452 A1
(43) Pub. Date: Sep. 2, 2021

(54) APPARATUS AND SYSTEM FOR MANAGING DISSOLVED GASES IN STORAGE TANKS

(71) Applicant: Bobby Gene Lee, Galesburg, IL (US)

(72) Inventor: Bobby Gene Lee, Galesburg, IL (US)

(21) Appl. No.: 17/186,165

(22) Filed: Feb. 26, 2021

Related U.S. Application Data
(60) Provisional application No. 62/982,967, filed on Feb. 28, 2020.

(51) Int. Cl. B01F 3/04; B01F 3/20; B01F 5/10; B01F 5/04; B01F 15/00; B01F 15/06; C02F 1/00; C02F 7/00; C02F 1/20

(52) U.S. Cl. CPC B01F 3/04503; B01F 3/2057; B01F 5/102; B01F 5/0415; B01F 15/00993; B01F 15/065; C02F 2103/20; C02F 7/00; C02F 1/20; B01F 2003/04872; B01F 2015/061; B01F 2215/0052; C02F 1/004

(57) ABSTRACT

An apparatus and system for managing the level of dissolved gases in water for aquatic life that provides sufficient water with sufficient oxygen saturation, without introducing excessive amounts of bubbles, and that can adequately degas or strip harmful dissolve gases from the water. The apparatus can generally comprise a storage compartment, a filter compartment, and a pump compartment. The filter compartment can be coupled with the storage compartment and comprise a filter element. The pump compartment can be coupled with the storage compartment and comprise a venturi air intake port, a degassing vent, a pump filter element, and a pump assembly. The pump assembly can comprise a venturi nozzle coupled with the venturi air intake port and a flow pump in fluid communication with a flow pump intake port. The pump filter element can at least partially encircle the flow pump intake port.

### CROSS-REFERENCE TO RELATED APPLICATIONS

This application claims priority to U.S. Provisional Patent Application No. 62/982,967, filed Feb. 28, 2020, to Bobby Gene Lee, entitled “An Apparatus and System for Managing Dissolved Gases in Storage Tanks,” currently pending, the entire disclosure of which, including the specification and drawings, is incorporated herein by reference.

### FIELD OF INVENTION

The present invention relates generally to fishing equipment and, more particularly, to an apparatus and system, and associated method for installing the same, for managing the levels of dissolved gases in the water of a storage tank for aquatic life.

### BACKGROUND OF THE INVENTION

Conventional storage designs for aquatic life lack adequate means for effectively managing the level of dissolved gases, including ammonia, carbon dioxide, and oxygen, in the subject water, and therefore fail to provide an optimal environment for temporarily storing the aquatic life for extended periods of time. Known means for managing the level of dissolved gases in water for aquatic life typically require the use of water circulation techniques that demand high volumetric flow rates (e.g., 1,000 gallons per hour). Such high-volume circulation techniques require large sources of water. For example, when such water circulation techniques are used on fishing boats, including freshwater and saltwater fishing boats, water is typically provided from the body of water in which the fishing boat is currently located. However, the surface water that is provided in these circumstances is suboptimal for various reasons, including its generally low oxygen saturation potential. Source water with low levels of oxygen saturation can be inadequate for certain aquatic life, including, without limitation, aquatic animals with passive gill ventilation and/or deep-water aquatic animals, as well as bait fish and other aquatic life. Further, at best, such high-volume circulation techniques only provide a suitable environment for the stored aquatic life for about three to six hours.

Other known means for managing the level of dissolved gases in water for aquatic life that use low-volume circulation techniques are not without their disadvantages. For example, in some circumstances, low-volume circulation techniques use aeration, such as providing air pumps to produce bubbles, to increase the amount of oxygen dissolved in the water. The amount of dissolved oxygen can be increased by increasing the amount of aeration or by increasing the amount of time that the water is subject to aeration. Additional amounts of aeration increase the presence of bubbles in the water, and in certain application, such as ram gill ventilation systems, and with certain aquatic life, such as delicate bait fish, the presence of bubbles in the holding tank can be disadvantageous or even deadly to the stored aquatic life. Additional time of aeration increases the risk of ammonia pollution in the water, as ammonia cannot be adequately degassed or stripped in such low-volume circulation techniques. Ammonia pollution can be toxic and extremely harmful to the stored aquatic life. This problem also applies to other harmful gases that may be dissolved in the water, including, without limitation, carbon dioxide.

Accordingly, a need exists for an apparatus and system for managing the level of dissolved gases in water for aquatic life that provides sufficient water with sufficient oxygen saturation, especially for, without limitation, aquatic animals with passive gill ventilation and deep-water aquatic animals, as well as bait fish and other aquatic life, without introducing excessive amounts of bubbles, wherein such apparatus and system can extend the amount of time that the aquatic life can be temporarily stored. Further, another need exists for an apparatus and system for managing the level of dissolved gases in water for aquatic life comprising low-volume circulation techniques that can adequately degas or strip harmful dissolve gases from the water, such as ammonia, carbon dioxide, and the like.

### SUMMARY

The present invention involves the provision of a modular aeration apparatus generally comprising a storage compartment, a filter compartment, and a pump compartment. The filter compartment can be coupled with the storage compartment and comprise a filter element. The pump compartment can be coupled with the storage compartment and comprise a venturi air intake port, a degassing vent, a pump filter element, and a pump assembly. The pump assembly can comprise a venturi nozzle coupled with the venturi air intake port and a flow pump in fluid communication with a flow pump intake port. The pump filter element can at least partially encircle the flow pump intake port.

In one embodiment, the storage compartment can comprise a plurality of ventilation tubes. In another embodiment, the storage compartment can also comprise at least one pump for urging water through the plurality of ventilation tubes. In yet another embodiment, the filter compartment can be coupled with the pump compartment. In even yet another embodiment, the modular aeration apparatus can also comprise a chilling compartment coupled with the storage compartment.

In another embodiment, the pump compartment can comprise a discharge hose, an internal discharge port, a return hose, an internal return port, and an external circuit of hoses. The discharge hose can be coupled with the flow pump. The internal discharge port can be in fluid communication with the discharge hose. The internal return port can be in fluid communication with the return hose. The external circuit of hoses can be in fluid communication with the internal discharge port and the internal return port.

In one embodiment, the external circuit of hoses can comprise an external discharge hose and an external return hose. In another embodiment, the external circuit of hoses can also comprise a t-fitting in fluid communication with the external discharge hose and the external return hose, and a source-water hose can be in fluid communication with the t-fitting. In yet another embodiment, the t-fitting can comprise a flow restrictor. In even yet another embodiment, the storage compartment can comprise an internal overflow port.

The present invention also involves the provision of a system for aerating circulated water generally comprising a storage compartment and at least one aeration apparatus. The at least one aeration apparatus can generally comprise a filter compartment and a pump compartment. The filter compartment can be coupled with the storage compartment and comprise a filter element. The pump compartment can be coupled with the storage compartment and comprise a venturi air intake port, a degassing vent, a pump filter element, and a pump assembly. The pump assembly can comprise a venturi nozzle coupled with the venturi air intake port and a flow pump in fluid communication with a flow pump intake port. The pump filter element can at least partially encircle the flow pump intake port.

In one embodiment, the storage compartment can comprise a plurality of ventilation tubes. In another embodiment, the storage compartment can also comprise at least one pump for urging water through the plurality of ventilation tubes. In yet another embodiment, the modular aeration apparatus can also comprise a chilling compartment coupled with the storage compartment.

In another embodiment, the pump compartment can comprise a discharge hose, an internal discharge port, a return hose, an internal return port, and an external circuit of hoses. The discharge hose can be coupled with the flow pump. The internal discharge port can be in fluid communication with the discharge hose. The internal return port can be in fluid communication with the return hose. The external circuit of hoses can be in fluid communication with the internal discharge port and the internal return port.

In one embodiment, the external circuit of hoses can comprise an external discharge hose and an external return hose. In another embodiment, the external circuit of hoses can also comprise a t-fitting in fluid communication with the external discharge hose and the external return hose, and a source-water hose can be in fluid communication with the t-fitting. In yet another embodiment, the t-fitting can comprise a flow restrictor.

The present invention also involves the method for installing a modular aeration apparatus generally comprising the steps of providing a modular aeration apparatus, storing at least one aquatic life in the storage compartment, transporting water to the filter compartment, circulating water to the pump compartment, recirculating water to the storage compartment, and urging water past the at least one aquatic life. The modular aeration apparatus can generally comprise a storage compartment, a filter compartment, and a pump compartment. The filter compartment can comprise a filter element. The pump compartment can comprise a venturi air intake port, a degassing vent, a pump filter element, and a pump assembly. The pump assembly can comprise a venturi nozzle coupled with the venturi air intake port and a flow pump in fluid communication with a flow pump intake port. The pump filter element can at least partially encircle the flow pump intake port.

In one embodiment, the pump compartment can comprise a discharge hose, an internal discharge port, a return hose, an internal return port, and an external circuit of hoses. The discharge hose can be coupled with the flow pump. The internal discharge port can be in fluid communication with the discharge hose. The internal return port can be in fluid communication with the return hose. The external circuit of hoses can be in fluid communication with the internal discharge port and the internal return port.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views.

FIG. 1 is a front elevation view of a modular aeration apparatus in accordance with one embodiment of the present invention;

FIG. 2 is a first side elevation view of the modular aeration apparatus of FIG. 1;

FIG. 3 is a rear elevation view of the modular aeration apparatus of FIGS. 1 and 2;

FIG. 4 is a second side elevation view of the modular aeration apparatus of FIGS. 1-3;

FIG. 5 is a top view of the modular aeration apparatus of FIGS. 1-4;

FIG. 6 is a first perspective view of ventilation tubes and a support tray of a modular aeration apparatus in accordance with one embodiment of the present invention;

FIG. 7 is a second perspective view of the ventilation tubes and support tray of the modular aeration apparatus of FIG. 6;

FIG. 8 is a top view of a modular aeration apparatus, with its lid assembly open and containing ventilation tubes and a support tray, in accordance with one embodiment of the present invention;

FIG. 9 is top view of the modular aeration apparatus of FIG. 8, with its lid assembly open, containing the support tray, and without the ventilation tubes;

FIG. 10 is top view of the modular aeration apparatus of FIGS. 8 and 9, with its lid assembly open and without the ventilation tubes and the support tray;

FIG. 11 is a detail perspective view of a filter compartment of a modular aeration apparatus, without a filter element, in accordance with one embodiment of the present invention;

FIG. 12 is a detail perspective view of a pump compartment of a modular aeration apparatus, without a pump assembly, in accordance with one embodiment of the present invention;

FIG. 13 is a perspective view of a pump assembly of a modular aeration apparatus in accordance with one embodiment of the present invention;

FIG. 14 is a detail perspective view of a pump compartment of a modular aeration apparatus, containing the pump assembly of FIG. 13, in accordance with one embodiment of the present invention;

FIG. 15 is a front elevation view of a modular aeration apparatus in accordance with one embodiment of the present invention;

FIG. 16 is a first side elevation view of the modular aeration apparatus of FIG. 15;

FIG. 17 is a rear elevation view of the modular aeration apparatus of FIGS. 15 and 16;

FIG. 18 is a second side elevation view of the modular aeration apparatus of FIGS. 15-17;

FIG. 19 is a top view of the modular aeration apparatus of FIGS. 15-18;

FIG. 20 is top view of a modular aeration apparatus, with its lid assembly open and without ventilation tubes and a support tray, in accordance with one embodiment of the present invention;

FIG. 21 is a detail perspective view of a pump compartment of a modular aeration apparatus, without a pump assembly, in accordance with one embodiment of the present invention;

FIG. 22 is a perspective view of a pump assembly of a modular aeration apparatus in accordance with one embodiment of the present invention;

FIG. 23 is a detail perspective view of a pump compartment of a modular aeration apparatus, containing the pump assembly of FIG. 22, in accordance with one embodiment of the present invention;

FIG. 24 a partial perspective view of a modular aeration apparatus, with an external circuit of hoses or tubing, in accordance with one embodiment of the present invention;

FIG. 25 is a top view schematic representation of a fishing vessel containing a modular aeration apparatus in accordance with one embodiment of the present invention;

FIG. 26 is a schematic representation of a modular aeration apparatus in accordance with one embodiment of the present invention;

FIG. 27 is a schematic representation of a modular aeration apparatus in accordance with another embodiment of the present invention;

FIG. 28 is a schematic representation of a modular aeration apparatus in accordance with yet another embodiment of the present invention;

FIG. 29 is a schematic representation of a modular aeration apparatus in accordance with even yet another embodiment of the present invention;

FIG. 30 is a diagram depicting an example method for installing a modular aeration apparatus in accordance with an embodiment of the present invention; and

FIG. 31 is a diagram depicting an example method for operating a modular aeration apparatus in accordance with an embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be understood that any dimensions included in herein are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention.

One objective of the present invention is to provide a means for preserving aquatic life, including, without limitation, game fish, live bait, and other aquatic animals and life, temporarily stored in a holding tank, including a storage tank. In one embodiment, the present invention can be directed toward preserving aquatic animals with passive gill ventilation, such as ram gill ventilation, including, without limitation, tuna, bonito, sharks, rays, and so on. In another embodiment, the present invention can be directed toward preserving other aquatic life, including bait fish and other aquatic life. Another objective of the present invention is to aerate, degas, and recirculate water into and through such holding tank, including a storage tank.

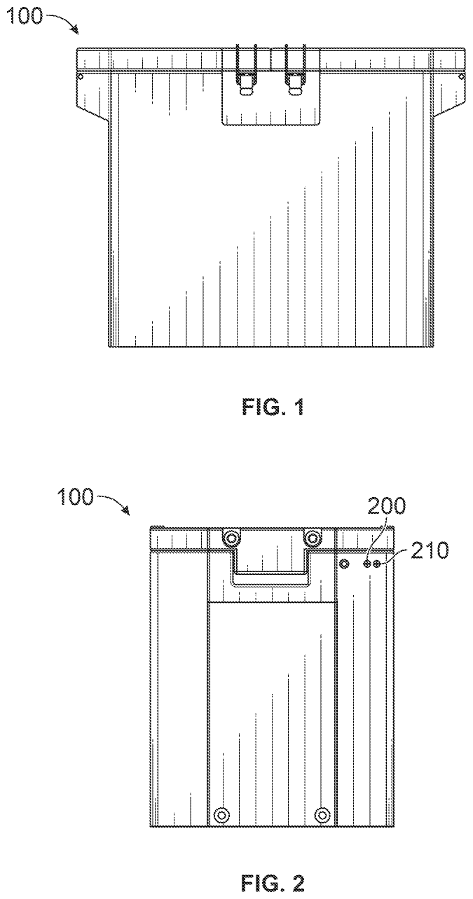

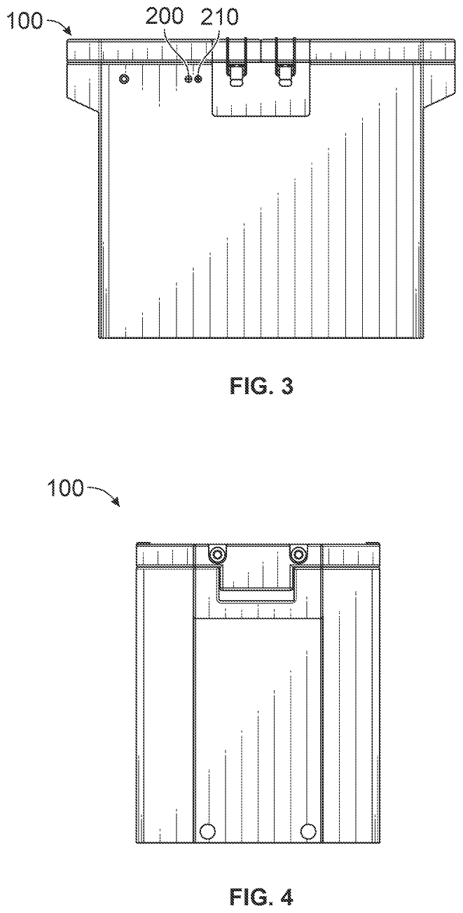

In one embodiment, the device can comprise a modular aeration apparatus 100. In one embodiment, the modular aeration apparatus 100 can be scalable, such that multiple modular aeration apparatuses 100 can be used in parallel to manage larger volumes of water. As shown in FIGS. 1-5, the modular aeration apparatus 100 can be a fully insulated rotational molded tank that can be adapted for temporarily storing aquatic life. As best shown in FIGS. 2 and 3, the modular aeration apparatus 100 can comprise a venturi air intake port 200 and a degassing vent 210. In one embodiment, the venturi air intake port 200 and the degassing vent 210 can be in fluid communication with a pump compartment 820 (as discussed herein). The degassing vent 210 can function to allow pressurized air or gas to exit a degassing compartment (as discussed herein) based on predetermined pressure levels or pressure differentials.

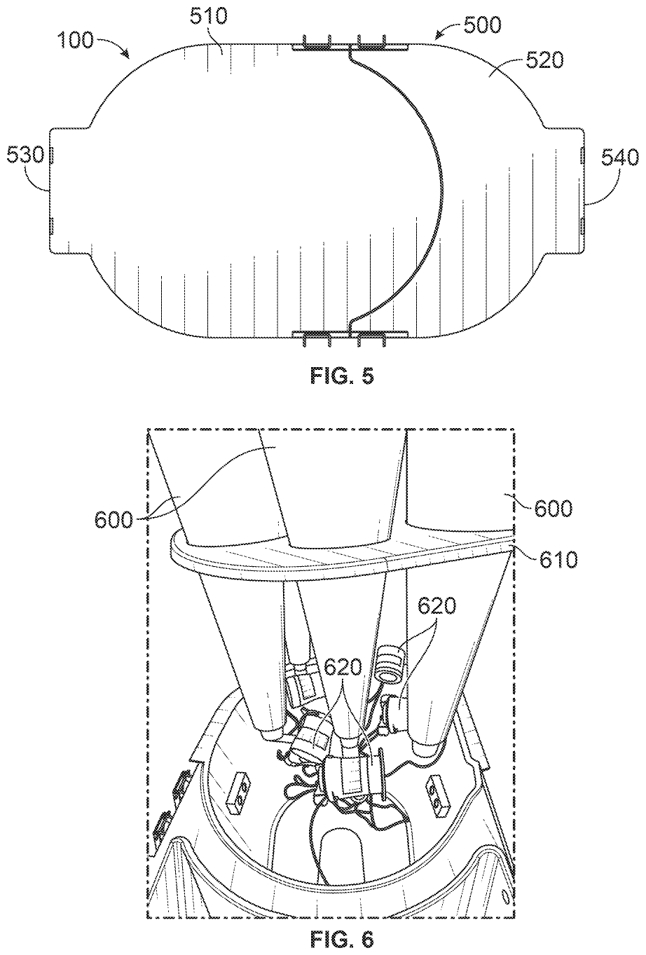

As best illustrated in FIG. 5, the modular aeration apparatus 100 can comprise a lid assembly 500. In one embodiment, the lid assembly 500 can comprise a first lid portion 510 and a second lid portion 520. The first lid portion 510 can be connected to the modular aeration apparatus 100 by a first lid pivoting mechanism 530. The second lid portion 520 can be connected to the modular aeration apparatus 100 by a second lid pivoting mechanism 540. Each lid pivoting mechanism 530, 540 can comprise a pinned hinge adjoining the modular aeration apparatus 100 to the respective first lid portion 510 or second lid portion 520. However, it will be understood that either lid pivoting mechanism 530, 540 can comprise any suitable mechanism for opening either the first lid portion 510 or the second lid portion 520 through a pivoting motion. The first lid portion 510 and the second lid portion 520 can be separate elements of the lid assembly 500, such that each can be selectively opened independently about the respective lid pivoting mechanism 530, 540. As shown in FIG. 5, in one embodiment, the first lid pivoting mechanism 530 can be located on an opposite side of the modular aeration apparatus 100 from the second lid pivoting mechanism 540, such that the first lid portion 510 and the second lid portion can open in opposite directions from one another.

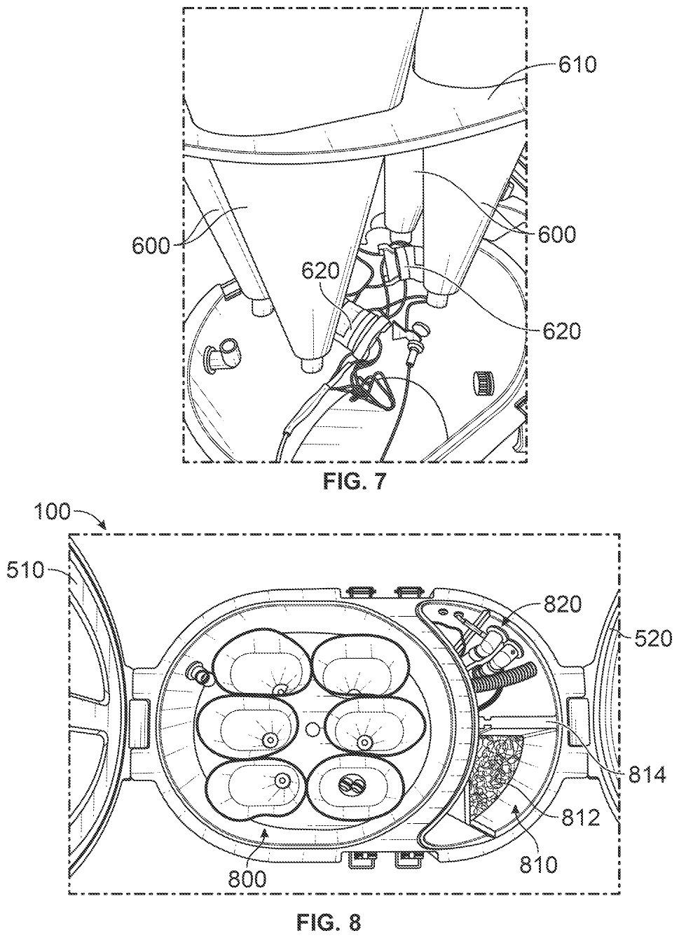

As depicted in FIGS. 6 and 7, the modular aeration apparatus 100 can comprise a plurality of ventilation tubes 600 and a support tray 610. The ventilation tubes 600 can be used to store, sustain, or support aquatic life. In certain embodiments, the dimensions of the ventilation tubes 600 can be sized to correspond with the size of the desired aquatic life to be stored, sustained, or supported therein. In one embodiment, the ventilation tubes 600 can comprise ram gill ventilation tubes for use with aquatic animals with passive gill ventilation. In another embodiment, the ventilation tubes 600 can comprise soft, flexible materials designed for use with aquatic animals with passive gill ventilation.

As further shown in FIGS. 6 and 7, the ventilation tubes 600 can be coupled with at least one pump 620. In one embodiment, as best shown in FIG. 6, each ventilation tube 600 can be coupled with an individual pump 620 to urge water through the ventilation tube 600 at a desired flow rate. In another embodiment, the ventilation tubes 600 can be housed within a storage compartment 800 (as discussed in more detail below), and the storage compartment 800 can comprise a single pump 620 for urging water through all of the ventilation tubes 600. In such embodiment, the single pump 620 can be coupled with a baffle or baffle system (not shown) to urge water through each of the ventilation tubes 600 as the desired a flow rate.

As shown in FIGS. 8-10, the modular aeration apparatus 100 can generally comprise a storage compartment 800, a filter compartment 810, and a pump compartment 820. The storage compartment 800 can be used for temporarily storing aquatic life. The storage compartment 800 can be coupled with the filter compartment 810 and/or the pump compartment 820. In one embodiment, the storage compartment 800 can be provided separate from the modular aeration apparatus 100. In another embodiment, the storage compartment 800 can be coupled with a fishing vessel. In yet another embodiment, the storage compartment 800 can be located on land.

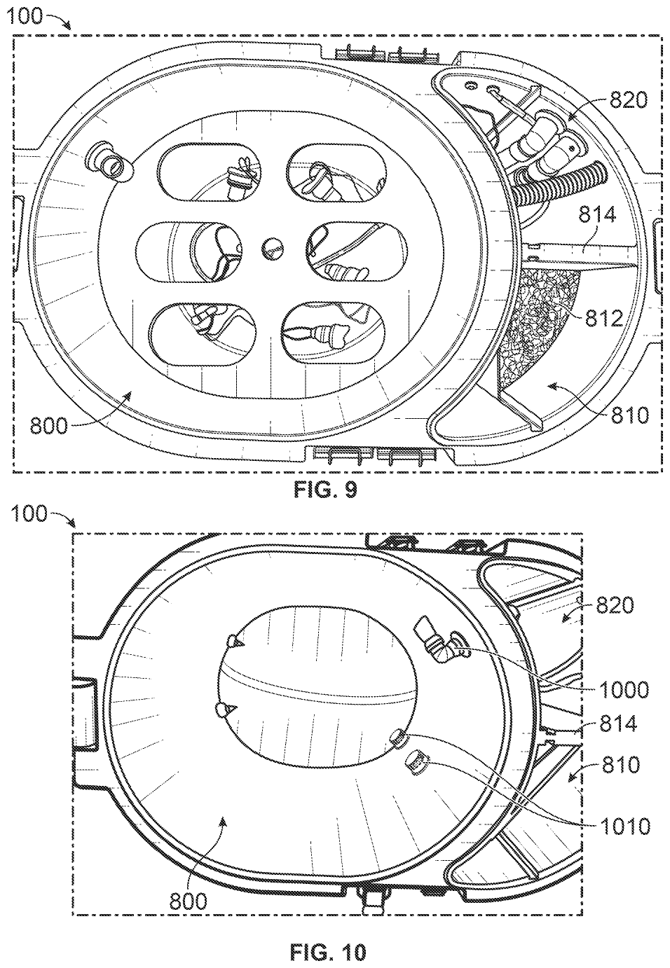

The filter compartment 810 can be coupled with the storage compartment 800 and/or the pump compartment 820. As further illustrated in FIGS. 8 and 9, the filter compartment 810 can comprise a filter element 812. The filter element 812 can comprise a variety of filters, skimmers, oxygen diffusers, venturi pump systems, and other suitable filter means. In one embodiment, the filter compartment 810 can be separated from another compartment, including the pump compartment 820, by a divider wall 814, as shown in FIGS. 8-10.

The pump compartment 820 can be coupled with the storage compartment 800 and/or the filter compartment 810. In one embodiment, the pump compartment 820 can be separated from another compartment be another divider wall (not shown).

As best illustrated in FIG. 8, the ventilation tubes 600 can be provided in the storage compartment 800 of the modular aeration apparatus 100. The number of ventilation tubes 600 provided in the storage compartment 800 can correspond with the dimensions of the ventilation tubes 600, the dimensions of the storage compartment 800, and the dimensions and/or desired amount of aquatic life to be stored, sustained, or supported therein.

In one embodiment, the ventilation tubes 600 can be adapted to provide laminar fluid flow at various flow rates. Such laminar fluid flows are non-turbulent and can be advantageous to provide the correct fluid state for the water to adequately provide oxygen to the aquatic life to be stored, sustained, or supported therein. The ventilation tubes 600 can be varied to provide laminar fluid flow at select flow rates based on the type of aquatic life to be stored, sustained, or supported therein.

In one embodiment, at least one pump 620 can be provided in the storage compartment 800 to urge the water through the ventilation tubes 600 at a desired flow rate or desired flow rates. In one embodiment, the at least one pump 620 can urge water through the ventilation tubes 600 from the bottom of the storage compartment 800, such that the water can travel across the ventilation tubes 600 in a laminar flow, starting at the bottom of the ventilation tubes 600 and ending at the top of the ventilation tubes 600. Such laminar flow of the water can travel through the gills of fish or aquatic life stored, sustained, or supported in the ventilation tubes 600 in a manner such that their heads can face vertically downward into a ventilation tubes 600.

FIG. 9 illustrates the storage compartment 800 with a support tray 610 for supporting ventilation tubes (not shown). The support tray 610 can ensure that the plurality of ventilation tubes maintain relative position within the storage compartment 800 during operation of the modular aeration apparatus 100. The support tray 610 can further provide structural support for the ventilation tubes. FIG. 10 illustrates the storage compartment 800 without the ventilation tubes (not shown) and the support tray (not shown). As best shown in FIG. 10, the storage compartment 800 can further comprise an inter-compartment discharge port 1000 and at least one inter-compartment exit port 1010. The inter-compartment discharge port 1000 can be in fluid communication with the pump compartment 820, such that, in one embodiment, the inter-compartment discharge port 1000 is adapted to circulate chilled, oxygenated water into the storage compartment 800 and through the ventilation tubes. The at least one inter-compartment exit port 1010 can transport water from the storage compartment 800 to the filter compartment 810.

In one embodiment, any of the compartments of the modular aeration apparatus 100 can comprise or function as an aerating compartment. In another embodiment, any of the compartments of the modular aeration apparatus 100 can comprise or function as a degassing compartment. In yet another embodiment, the aerating compartment and the degassing compartment can comprise the same compartment. Any of the compartments that comprise or function as the aerating compartment can be coupled with the storage compartment 800. Any of the compartments that comprise or function as the degassing compartment can be coupled with the storage compartment 800.

In another embodiment, the modular aeration apparatus 100 can further comprise a chilling compartment (not shown). In one embodiment, the chilling compartment can be adapted to chill a liquid passing therethrough. Chilled water can be advantageous because it has a higher oxygen saturation potential. The chilling compartment can be coupled with the storage compartment 800. In another embodiment, the chilling compartment can be coupled with the compartment of the modular aeration apparatus 100 comprising or functioning as an aerating compartment. In yet another embodiment, the chilling compartment can be coupled with the compartment of the modular aeration apparatus 100 comprising or functioning as a degassing compartment.

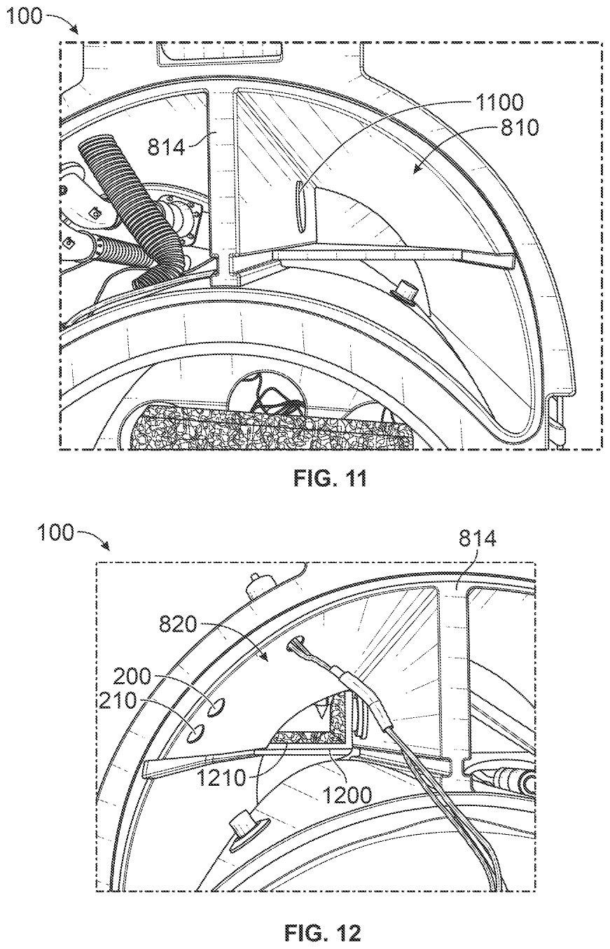

FIG. 11 is a detail perspective view of the filter compartment 810, and illustrates the filter compartment 810 without a filter element 812. As best illustrated in FIG. 11, the divider wall 814 can comprise a fitting 1100 that can be adapted to permit the flow of water between the filter compartment 810 and a second compartment, which can include the pump compartment 820.

As shown in FIGS. 12-14, the pump compartment 820 can comprise a pump base 1200, a pump assembly 1300, a return hose 1310, and a discharge hose 1400. As best illustrated in FIG. 12, the pump compartment 820 can be coupled with the venturi air intake port 200 and the degassing vent 210. As further illustrated in FIG. 12, the pump base 1200 can be received in a portion of the pump compartment 820. For example, in one embodiment, the pump base 1200 can be received in and coupled with a lower portion of the pump compartment 820, including at or near the bottom of the pump compartment 820. The pump base 1200 can be fixedly attached to the modular aeration apparatus 100, including in the pump compartment 820, via fastening means, including, without limitation, through welds, bolts, pins, or other suitable means. In another embodiment, the pump base 1200 can be generally L-shaped.

In one embodiment, as shown in FIG. 12, the pump base 1200 can be coupled with a pump filter element 1210. In another embodiment, the combination of the pump base 1200 and the pump filter element 1210 can support the pump assembly 1300 in the pump compartment 820. The pump base 1200 can be used to support the pump assembly 1300, including to ensure proper separation between the pump assembly 1300 and any components of the pump compartment 820, including the walls and sides thereof.

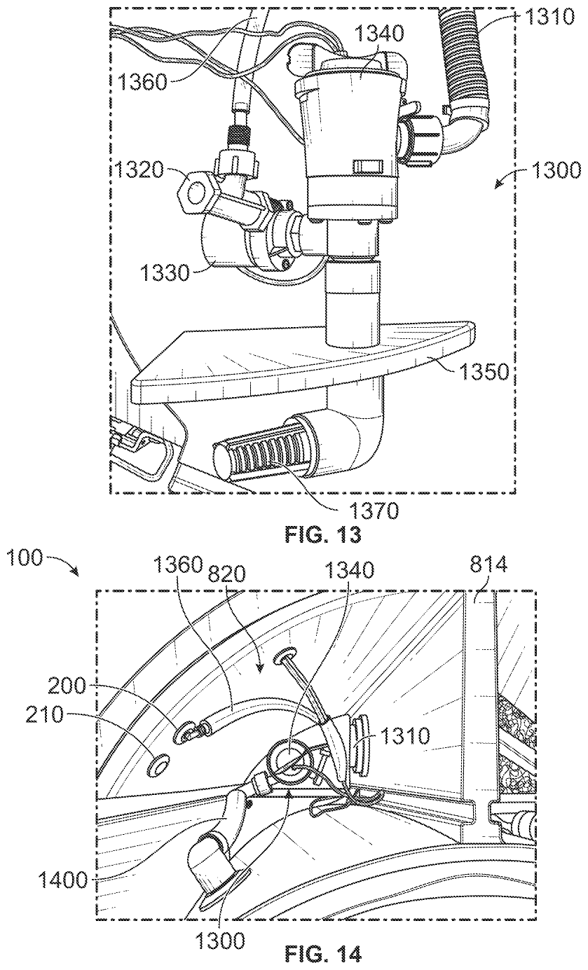

As best illustrated in FIG. 13, the pump assembly 1300 can comprise several components, including, without limitation, a return hose 1310, a venturi nozzle 1320, a venturi pump 1330, a flow pump 1340, and a pump base support 1350. The pump assembly 1300 can be fixedly attached to the modular aeration apparatus 100 via the pump base 1200. In one embodiment, the pump base 1200 can receive the pump base support 1350. In another embodiment, the pump base support 1350 can be fixedly attached to the pump base 1200 via fastening means, including, without limitation, through welds, bolts, pins, or other suitable means.

The venturi nozzle 1320 can be coupled with the venturi pump 1330. The venturi pump 1330 can collect and urge air through the venturi nozzle 1320, including air provided by a venturi air intake hose 1360 coupled and in fluid communication with the venturi air intake port 200, as best illustrated in FIG. 14. In one embodiment, the flow of liquid or gas through the venturi nozzle 1320 can create bubbles in a liquid, including water, in the pump compartment 820. The bubbles can cause the liquid to be aerated. By aerating the liquid in the pump compartment 820, the pump compartment 820 can comprise or function as an aerating compartment. The bubbles can also agitate the water and degas or strip harmful gasses from the water, including ammonia, carbon dioxide, and other toxins. By degassing or stripping the liquid in the pump compartment 820, the pump compartment 820 can comprise or function as a degassing compartment. The stripped gases can then exit the apparatus 100 via the degassing vent 210. In one embodiment, the venturi pump 1330 can be in fluid communication with the flow pump 1340.

In another embodiment, as best illustrated in FIG. 13, the flow pump 1340 can comprise and be in fluid communication with a flow pump intake port 1370. The flow pump intake port 1370 can function to provide fluid available in the pump compartment 820 to the flow pump 1340. In one embodiment, the flow pump intake port 1370 can be located at the lower end or bottom portion of the pump assembly 1300, including below the pump base support 1350, as shown in FIG. 13.

As best illustrated in FIG. 14, in one embodiment, the pump compartment 820 can be in fluid communication with the storage compartment 800, including via the pump assembly 1300, including the flow pump 1340 and the flow pump intake port 1370, and the discharge hose 1400. In another embodiment, the venturi air intake port 200 can be in fluid communication with the venturi nozzle 1320 and/or the venturi pump 1330, including via the venturi air intake hose 1360.

In one embodiment, the combination of the pump base 1200 with a pump filter element 1210 can prevent air bubbles from entering the venturi pump 1330 and/or the flow pump 1340, including through the flow pump intake port 1370. In another embodiment, the pump filter element 1210 can generally and at least partially encircle the flow pump intake port 1370 to prevent air bubbles from reaching the same. Such bubbles can be created by the venturi nozzle 1320 and/or the venturi pump 1330 as part of the aerating process and/or degassing process. In another embodiment, the pump base support 1350 can be generally solid or impervious and, when fixedly attached to the pump base 1200, can prevent fluid and/or air bubbles from entering the flow pump intake port 1370 without passing through the pump filter element 1210 of the pump base 1200. Preventing air bubbles from entering the venturi pump 1330 and/or the flow pump 1340 is advantageous, because it is important for the pump assembly 1300 to not transport bubbles to the storage compartment 800, where aquatic life may be stored, sustained, or supported. If bubbles are introduced into the storage compartment 800, this can be harmful or even deadly to any aquatic life stored, sustained, or supported therein. This can be especially true for aquatic animals with passive gill ventilation, such as ram gill ventilation, or deep-water aquatic animals. This can also be true for delicate bait fish and other aquatic life, because the presence of bubbles in the storage compartment 800 can create over-agitation of the liquid. Additionally, the presence of bubbles in the storage compartment 800 can create a thick blanket of foam, which may require the use of monoglycerides or foam-off to make the foam water-soluble. However, the use of monoglycerides or foam-off can lead to poor water quality. In yet another embodiment, the combination of the pump base 1200 and the pump filter element 1210, as well as the pump base support 1350, can prevent debris from entering the venturi pump 1330 and/or the flow pump 1340, which prevents certain deleterious effects thereof.

In one embodiment, the pump compartment 820 can be used to degas or strip ammonia, carbon dioxide, and other toxins from the liquid in the pump compartment 820. By degassing or stripping ammonia, carbon dioxide, and other toxins from the liquid in the pump compartment 820, the pump compartment 820 can comprise or function as a degassing compartment. In another embodiment, the degassing vent 210 can be in fluid communication with pump compartment 820. The degassing vent 210 can allow the pump compartment 820, as the degassing compartment, to remain completely sealed, including during any aerating and/or degassing process, without causing an air lock. Such an air lock could negatively affect the venturi nozzle 1320 and/or the venturi pump 1330. In yet another embodiment, the degassing vent 210 can allow pressurized air, which may accumulate from the use of the venturi nozzle 1320 and/or venturi pump 1330, and the bubbles created thereby, to selectively exit the pump compartment 820, as the degassing compartment, in a one-way manner. Without allowing pressurized air to selectively exit the pump compartment 820, as the degassing compartment, this could render the venturi nozzle 1320 and/or the venturi pump 1330 incapable of producing the necessary bubbles to agitate the fluid for aeration purposes, which can limit the ability of the modular aeration apparatus 100 to increase the oxygen saturation levels of the fluid.

In another embodiment, wherein the pump compartment 820 comprises the degassing compartment to degas or strip ammonia, carbon dioxide, and other toxins from the liquid in the pump compartment 820, the pump compartment 820 can further comprise a divider wall (not shown). The divider wall can comprise a small recessed surface that can serve as a vent and permit the flow of liquid or gas between the degassing compartment of the pump compartment 820 and the remainder of the pump compartment 820. In one embodiment, the recessed surface can permit the flow of liquid or gas only from one compartment of the pump compartment 820 (e.g., the degassing compartment or any other compartment of the pump compartment 820) to another compartment. In another embodiment, the recessed surface can permit the flow of liquid or gas simultaneously between both of the compartments (e.g., the degassing compartment or any other compartment of the pump compartment 820). Permitting liquid or gas to flow between two compartments of the pump compartment 820 can prevent the undesirable build up and increase of pressure in one or both of the compartments of the pump compartment 820. In one embodiment, the recessed surface of the divider wall can also allow for adjacent compartments of the pump compartment 820 to be rearranged, such that functions and components of one compartment can be placed or relocated in another compartment of the pump compartment 820, and vice versa. In another embodiment, the recessed surface of the divider wall can further allow the adjacent compartments to be duplicated, such that functions and components of one compartment of the pump compartment 820 can also be placed in another compartment of the pump compartment 820.

As best illustrated in FIG. 14, the pump compartment 820 can comprise the return hose 1310 and the discharge hose 1400. In one embodiment, the discharge hose 1400 can transport oxygenated, degassed water out of the pump compartment 820, including, without limitation, to the storage compartment 800. In another embodiment, the discharge hose 1400 can transport oxygenated, degassed water out of the pump compartment 820 to a chilling compartment before transporting the oxygenated, degassed water to the storage compartment 800. The return hose 1310 can transport water from another compartment, including the storage compartment 800, to the pump compartment 820. In one embodiment, the return hose 1310 can be coupled and in fluid communication with the fitting 1100. In another embodiment, the return hose 1310 can transport water from another compartment, including the storage compartment 800, through the filter compartment 810 before returning the water to the pump compartment 820. In one embodiment, the return hose 1310 and the discharge hose 1400 can be in fluid communication with each other and can comprise a closed fluid loop. In another embodiment, the return hose 1310 can pass through the pump compartment 820 to be in direct fluid communication with the storage compartment 800. In yet another embodiment, the return hose 1310 can merely pass through the pump compartment 820, such that an internal portion (not shown) of the return hose 1310 is not in fluid communication with the pump compartment 820.

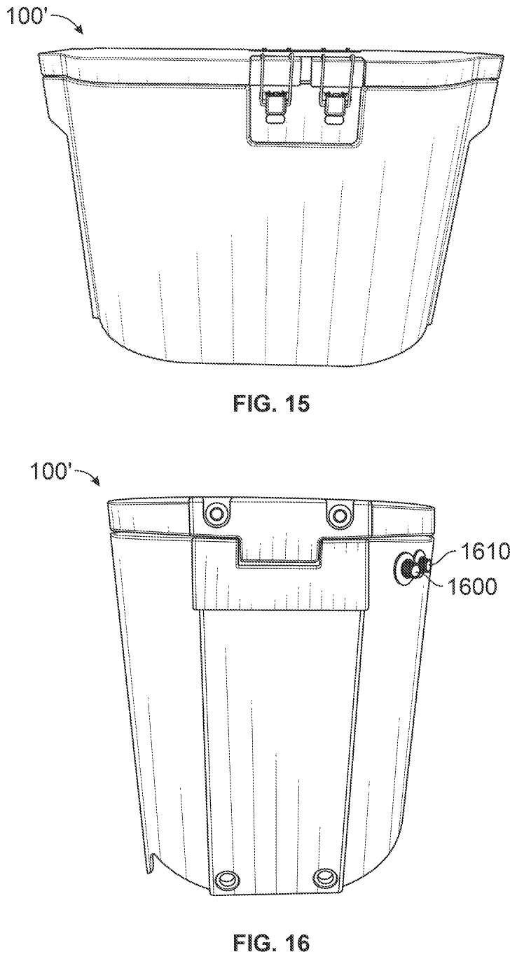

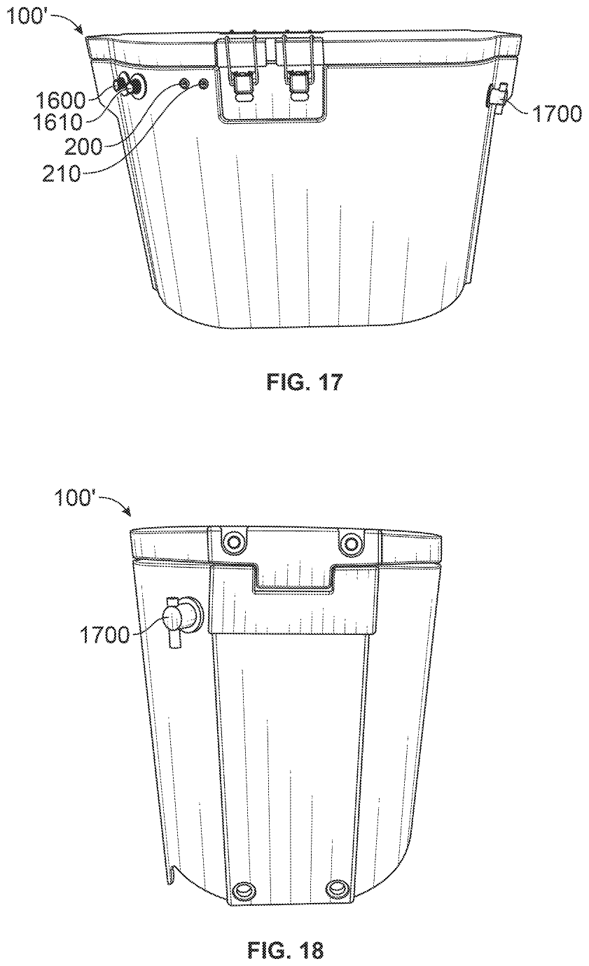

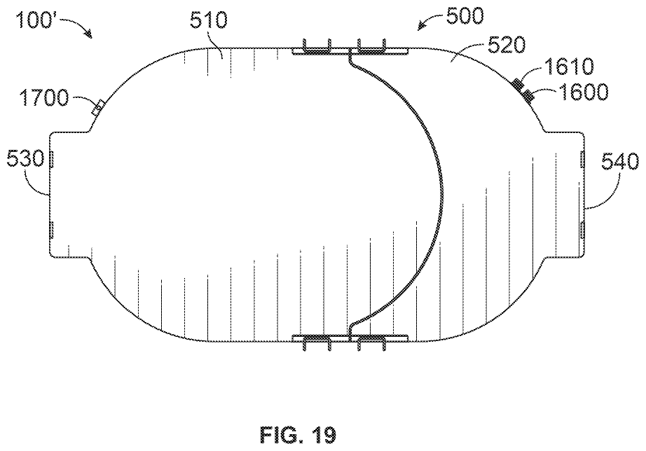

In another embodiment, the device can comprise a modular aeration apparatus 100′. In one embodiment, the modular aeration apparatus 100′ can be scalable, such that multiple modular aeration apparatuses 100′ can be used in parallel to manage larger volumes of water. As shown in FIGS. 15-19, the modular aeration apparatus 100′ can be a fully insulated rotational molded tank that can be adapted for temporarily storing aquatic life. As best illustrated in FIGS. 16 and 17, the modular aeration apparatus 100′ can comprise an external discharge port 1600 and an external return port 1610. In one embodiment, the external discharge port 1600 and/or the external return port 1610 can be in fluid communication with the pump compartment 820. As shown in FIG. 17, the modular aeration apparatus 100′ can further comprise a venturi air intake port 200 and a degassing vent 210. In one embodiment, the venturi air intake port 200 and the degassing vent 210 can be in fluid communication with a pump compartment 820′. The degassing vent 210 can function to allow pressurized air or gas to exit a degassing compartment based on predetermined pressure levels or pressure differentials. As shown in FIGS. 17 and 18, the modular aeration apparatus 100′ can comprise an external overflow port 1700. The external overflow port 1700 can be in fluid communication with the storage compartment 800. As best illustrated in FIG. 19, the modular aeration apparatus 100′ can comprise a lid assembly 500 (as discussed herein).

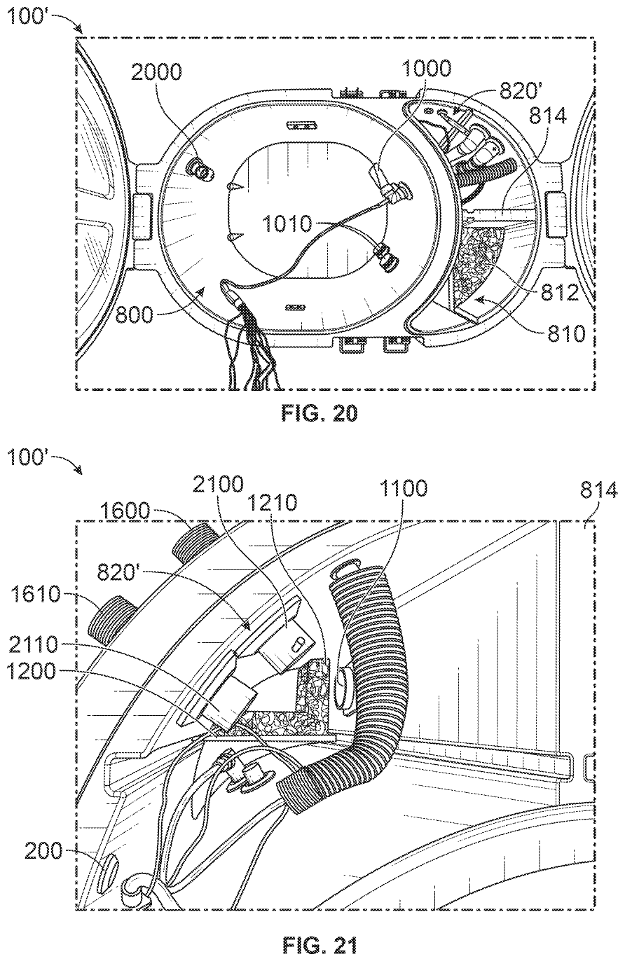

As shown in FIG. 20, the modular aeration apparatus 100′ can generally comprise a storage compartment 800, a filter compartment 810, and a pump compartment 820′. The storage compartment 800 can be used for temporarily storing aquatic life. The storage compartment 800 can be coupled with the filter compartment 810 and/or the pump compartment 820′. The filter compartment 810 can be coupled with the storage compartment 800 and/or the pump compartment 820′. The pump compartment 820′ can be coupled with the storage compartment 800 and/or the filter compartment 810.

As illustrated in FIG. 20, the storage compartment 800 can comprise an inter-compartment discharge port 1000, at least one inter-compartment exit port 1010, and an internal overflow port 2000. The inter-compartment discharge port 1000 can be in fluid communication with the pump compartment 820′, such that, in one embodiment, the inter-compartment discharge port 1000 is adapted to circulate chilled, oxygenated water into the storage compartment 800 and through ventilation tubes (not shown). The at least one inter-compartment exit port 1010 can transport water from the storage compartment 800 to the filter compartment 810. The internal overflow port 2000 can be in fluid communication with the external overflow port 1700. As further illustrated in FIG. 20, the filter compartment 810 can comprise a filter element 812. In one embodiment, the filter compartment 810 can be separated from another compartment, including the pump compartment 820′, by a divider wall 814, as shown in FIG. 20. In one embodiment, the pump compartment 820′ can be separated from another compartment by another divider wall (not shown).

In one embodiment, any of the compartments of the modular aeration apparatus 100′ can comprise or function as an aerating compartment. In another embodiment, any of the compartments of the modular aeration apparatus 100′ can comprise or function as a degassing compartment. In yet another embodiment, the aerating compartment and the degassing compartment can comprise the same compartment. Any of the compartments that comprise or function as the aerating compartment can be coupled with the storage compartment 800. Any of the compartments that comprise or function as the degassing compartment can be coupled with the storage compartment 800.

In another embodiment, the modular aeration apparatus 100′ can further comprise a chilling compartment (not shown). In one embodiment, the chilling compartment can be adapted to chill a liquid passing therethrough. The chilling compartment can be coupled with the storage compartment 800. In another embodiment, the chilling compartment can be coupled with the compartment of the modular aeration apparatus 100′ comprising or functioning as an aerating compartment. In yet another embodiment, the chilling compartment can be coupled with the compartment of the modular aeration apparatus 100′ comprising or functioning as a degassing compartment.

As shown in FIGS. 21-23, the pump compartment 820′ can comprise a pump base 1200, a pump assembly 1300′, a return hose 1310, and a discharge hose 1400. As further illustrated in FIG. 21, the pump base 1200 can be received in a portion of the pump compartment 820′. For example, in one embodiment, the pump base 1200 can be received in and coupled with a lower portion of the pump compartment 820′, including at or near the bottom of the pump compartment 820′. The pump base 1200 can be fixedly attached to the modular aeration apparatus 100′, including in the pump compartment 820′, via fastening means, including, without limitation, through welds, bolts, pins, or other suitable means. In one embodiment, as shown in FIG. 21, the pump base 1200 can be coupled with a pump filter element 1210. In another embodiment, the combination of the pump base 1200 and the pump filter element 1210 can support the pump assembly 1300′ in the pump compartment 820′. The pump base 1200 can be used to support the pump assembly 1300′, including to ensure proper separation between the pump assembly 1300′ and any components of the pump compartment 820′, including the walls and sides thereof.

As best illustrated in FIG. 21, the pump compartment 820′ can further comprise a fitting 1100, an internal discharge port 2100, and an internal return port 2110. The fitting 1100 can be adapted to permit the flow of water between the pump compartment 820′ and a second compartment, which may include the filter compartment 810. In one embodiment, the internal discharge port 2100 can be in fluid communication with the external discharge port 1600. In another embodiment, the internal return port 2110 can be in fluid communication with the external return port 1610. As further illustrated in FIG. 21, the pump compartment 820′ can be coupled with the venturi air intake port 200.

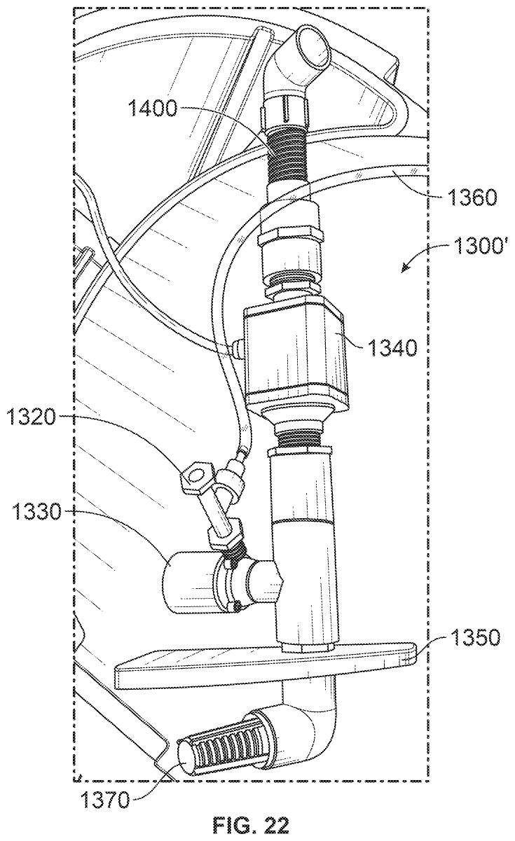

As best illustrated in FIG. 22, the pump assembly 1300′ can comprise several components, including, without limitation, a venturi nozzle 1320, a venturi pump 1330, a flow pump 1340, a pump base support 1350, a venturi air intake hose 1360, a flow pump intake port 1370, and a discharge hose 1400. The pump assembly 1300′ can be fixedly attached to the modular aeration apparatus 100′ via the pump base 1200. In one embodiment, the venturi pump 1330 can collect and urge air through the venturi nozzle 1320, including air provided by a venturi air intake hose 1360 coupled and in fluid communication with the venturi air intake port 200, which can create bubbles in a liquid, including water, in the pump compartment 820′. The bubbles can cause the liquid to be aerated. By aerating the liquid in the pump compartment 820′, the pump compartment 820′ can comprise or function as an aerating compartment. The bubbles can also agitate the water and degas or strip harmful gasses from the water, including ammonia, carbon dioxide, and other toxins. By degassing or stripping the liquid in the pump compartment 820′, the pump compartment 820′ can comprise or function as a degassing compartment.

In another embodiment, as best illustrated in FIG. 22, the flow pump 1340 can comprise and be in fluid communication with a flow pump intake port 1370. The flow pump intake port 1370 can function to provide fluid available in the pump compartment 820′ to the flow pump 1340. In one embodiment, the flow pump intake port 1370 can be located at the lower end or bottom portion of the pump assembly 1300′, including below the pump base support 1350, as shown in FIG. 21.

In one embodiment, the combination of the pump base 1200 with a pump filter element 1210 can prevent air bubbles from entering the venturi pump 1330 and/or the flow pump 1340, including through the flow pump intake port 1370. In another embodiment, the pump filter element 1210 can generally and at least partially encircle the flow pump intake port 1370 to prevent air bubbles from reaching the same. Such bubbles may be created by the venturi nozzle 1320 and/or the venturi pump 1330 as part of the aerating process and/or degassing process. In another embodiment, the pump base support 1350 can be generally solid or impervious and, when fixedly attached to the pump base 1200, can prevent fluid and/or air bubbles from entering the flow pump intake port 1370 without passing through the pump filter element 1210 of the pump base 1200. Preventing air bubbles from entering the venturi pump 1330 and/or the flow pump 1340 is advantageous, because it is important for the pump assembly 1300′ to not transport bubbles to the storage compartment 800, where aquatic life may be stored, sustained, or supported. In yet another embodiment, the combination of the pump base 1200 and the pump filter element 1210, as well as the pump base support 1350, can prevent debris from entering the venturi pump 1330 and/or the flow pump 1340, which prevents certain deleterious effects thereof.

In one embodiment, the pump compartment 820′ can be used to degas or strip ammonia, carbon dioxide, and other toxins from the liquid in the pump compartment 820′. By degassing or stripping ammonia, carbon dioxide, and other toxins from the liquid in the pump compartment 820′, the pump compartment 820′ can comprise or function as a degassing compartment. In another embodiment, the degassing vent 210 can be in fluid communication with pump compartment 820′. The degassing vent 210 can allow the pump compartment 820′, as the degassing compartment, to remain completely sealed, including during any aerating and/or degassing process, without causing an air lock. Such an air lock could negatively affect the venturi nozzle 1320 and/or the venturi pump 1330. In yet another embodiment, the degassing vent 210 can allow pressurized air, which may accumulate from the use of the venturi nozzle 1320 and/or venturi pump 1330, and the bubbles created thereby, to selectively exit the pump compartment 820′, as the degassing compartment, in a one-way manner. Without allowing pressurized air to selectively exit the pump compartment 820′, as the degassing compartment, this could render the venturi nozzle 1320 and/or the venturi pump 1330 incapable of producing the necessary bubbles to agitate the fluid for aeration purposes, which can limit the ability of the modular aeration apparatus 100′ to increase the oxygen saturation levels of the fluid.

In another embodiment, wherein the pump compartment 820′ comprises the degassing compartment to degas or strip ammonia, carbon dioxide, and other toxins from the liquid in the pump compartment 820′, the pump compartment 820′ can further comprise a divider wall (not shown). The divider wall may comprise a small recessed surface that can serve as a vent and permit the flow of liquid or gas between the degassing compartment of the pump compartment 820′ and the remainder of the pump compartment 820′. In one embodiment, the recessed surface can permit the flow of liquid or gas only from one compartment of the pump compartment 820′ (e.g., the degassing compartment or any other compartment of the pump compartment 820′) to another compartment. In another embodiment, the recessed surface can permit the flow of liquid or gas simultaneously between both of the compartments (e.g., the degassing compartment or any other compartment of the pump compartment 820′). Permitting liquid or gas to flow between two compartments of the pump compartment 820′ can prevent the undesirable build up and increase of pressure in one or both of the compartments of the pump compartment 820′. In one embodiment, the recessed surface of the divider wall can also allow for adjacent compartments of the pump compartment 820′ to be rearranged, such that functions and components of one compartment can be placed or relocated in another compartment of the pump compartment 820′, and vice versa. In another embodiment, the recessed surface of the divider wall can further allow the adjacent compartments to be duplicated, such that functions and components of one compartment of the pump compartment 820′ can also be placed in another compartment of the pump compartment 820′.

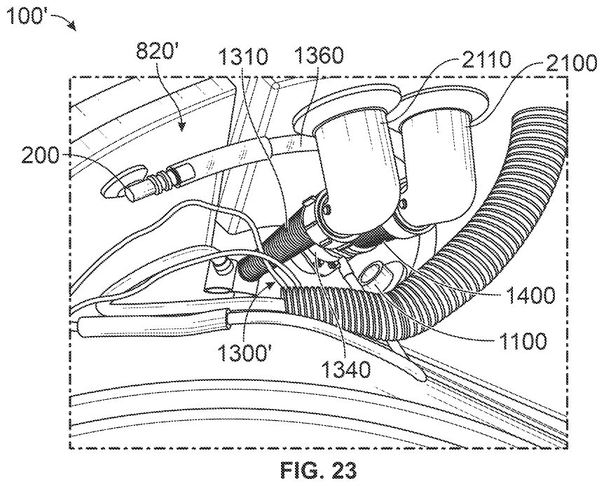

As best illustrated in FIG. 23, in one embodiment, the pump compartment 820′ can be in fluid communication with the storage compartment 800, including via the pump assembly 1300′, including the flow pump 1340 and the flow pump intake port 1370, and the return hose 1310. The arrangement of the pump assembly 1300′, as shown in FIGS. 22 and 23, can allow for the flow pump 1340 to urge a liquid, including water, to an external circuit of hoses or tubing 2400 (as discussed in more detail below), including through the discharge hose 1400 and the external discharge port 1600, including via the internal discharge port 2100. In such embodiment, external liquid, including water from an external source (e.g., lake, pond, or freshwater and saltwater bodies of water) can enter the external circuit of hoses or tubing 2400 and be returned to the modular aeration apparatus 100′, including to the storage compartment 800 or the pump compartment 820′. Specifically, the general length of the pump assembly 1300′ can allow for the pump assembly 1300′ to urge water from the flow pump intake port 1370 to the internal discharge port 2100, so that it can be urged through the external discharge port 1600. In one embodiment, the flow pump 1340 may comprise a high-powered pump to urge the water to the internal discharge port 2100 so that it can travel through an external circuit of hoses or tubing 2400.

As best illustrated in FIG. 23, the pump compartment 820′ can comprise the return hose 1310 and the discharge hose 1400. In one embodiment, the discharge hose 1400 can transport oxygenated, degassed water out of the pump compartment 820′, including, without limitation, to the external circuit of hoses or tubing 2400. In another embodiment, the discharge hose 1400 can transport oxygenated, degassed water out of the pump compartment 820′ to a chilling compartment before transporting the oxygenated, degassed water to the external circuit of hoses or tubing 2400. In one embodiment, the return hose 1310 can be coupled and in fluid communication with the pump compartment 800 and can transport oxygenated, degassed water, including water that may contain water from an external source (e.g., lake, pond, or freshwater and saltwater bodies of water), to the storage compartment 800, including through the discharge port 1000. In one embodiment, the return hose 1310 can pass through the pump compartment 820′ to be in direct fluid communication with the storage compartment 800. In another embodiment, the return hose 1310 can merely pass through the pump compartment 820′, such that an internal portion (not shown) of the return hose 1310 is not in fluid communication with the pump compartment 820′.

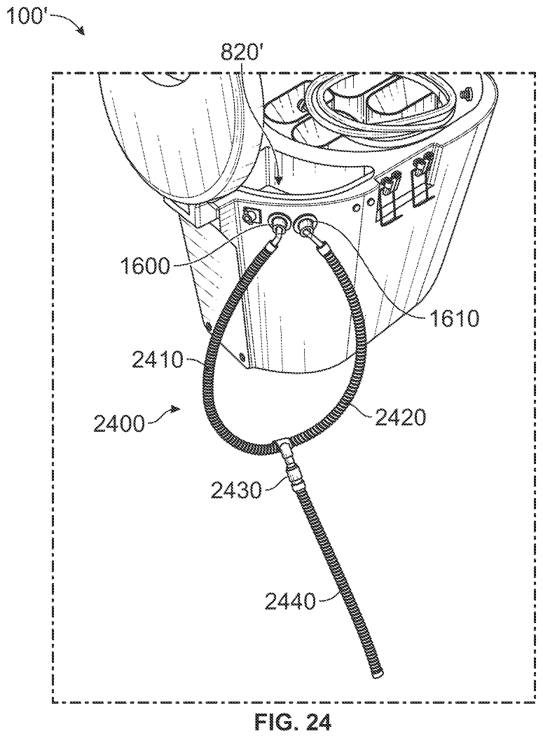

As best illustrated in FIG. 24, in one embodiment, the external circuit of hoses or tubing 2400 can comprise an external discharge hose 2410 and an external return hose 2420. The external discharge hose 2410 and the external return hose 2420 can be in fluid communication with each other and can comprise a closed fluid loop. In another embodiment, the external circuit of hoses or tubing 2400 can further comprise a t-fitting 2430. In yet another embodiment, the t-fitting 2430 can be in fluid communication with a source-water hose 2440. The t-fitting 2430 can be adapted to selectively add water from an external source (e.g., lake, pond, or freshwater and saltwater bodies of water) to the external circuit of hoses or tubing 2400, before the water contained therein enters the storage compartment 800, the pump compartment 820′, or a chilling compartment. In one embodiment, the chilled water can be transported to the storage compartment 800 via the return hose 1310, including through the pump compartment 820′. The source-water hose 2440 can provide water to the modular aeration apparatus 100′ from an external source (e.g., lake, pond, or freshwater and saltwater bodies of water). In another embodiment, the t-fitting 2430 can comprise a flow restrictor (not shown). The flow restrictor can be adapted for precisely controlling the amount of source water added to the external circuit of hoses or tubing 2400, including the external discharge hose 2410 and the external return hose 2420. The flow restrictor can further be adapted to limit the entry of external water into the external circuit of hoses or tubing 2400 based on the pump pressure and predetermined water volume preferences for the modular aeration apparatus 100′. The amount of source water added to the external circuit of hoses or tubing 2400 can be used to manipulate the function of the modular aeration apparatus 100′ in several ways, including, without limitation, controlling the temperature and/or oxygen saturation potential of the water of the modular aeration apparatus 100′. In one embodiment, the t-fitting 2430 can be adapted to selectively be opened and allow external source water to enter the external circuit of hoses or tubing 2400, including the external discharge hose 2410 and the external return hose 2420, effectively selectively making the modular aeration apparatus 100′ an open system. In another embodiment, the t-fitting 2430 can be adapted to selectively close off the modular aeration apparatus 100′ from an external source water, effectively selectively making the modular aeration apparatus 100′ a closed system. In yet another embodiment, the t-fitting 2430 can be adapted to permit the partial addition of source water to external circuit of hoses or tubing 2400, including the external discharge hose 2410 and the external return hose 2420, at a desired rate (e.g., at half-gallon per minute, or increasing increments of half-gallon per minute up to five gallons per minute), effectively selectively making the modular aeration apparatus 100′ a hybrid system. If excess water is provided to the modular aeration apparatus 100′ from the external source (e.g., lake, pond, or freshwater and saltwater bodies of water), it can be drained from the storage compartment 800 through the external overflow port 1700, including via the internal overflow port 2000, which may be directly proportional to the amount of source water introduced to the external circuit of hoses or tubing 2400, including via the t-fitting 2430 and/or source-water hose 2440.

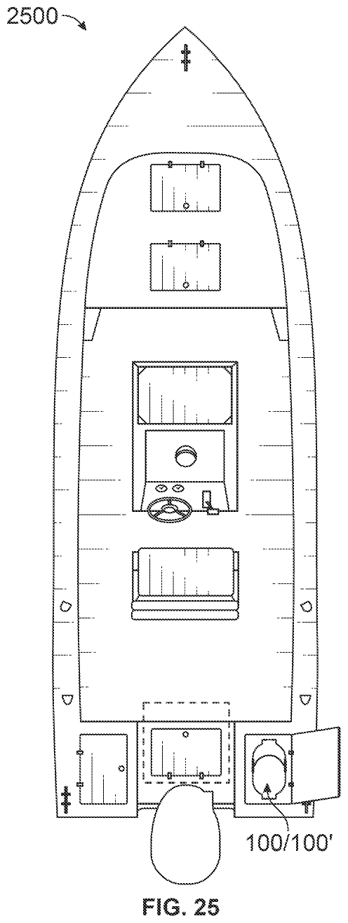

As best illustrated in FIG. 25, in another embodiment, the modular aeration apparatus 100, 100′ can be installed in or otherwise coupled with a fishing vessel 2500. In one embodiment, the modular aeration apparatus 100, 100′ can be coupled with a storage compartment of the fishing vessel 2500. The modular aeration apparatus 100, 100′ can be coupled with an existing storage compartment or a livewell of the fishing vessel 2500. The modular aeration apparatus 100, 100′ can be stored in a dry compartment of the fishing vessel 2500. In yet another embodiment, multiple modular aeration apparatuses 100, 100′ can be installed on the same fishing vessel 2500 to create a system of aeration apparatuses for aerating and degassing water. It will be understood, however, that the modular aeration apparatus 100, 100′ described herein can be used in other applications other than with a fishing vessel 2500

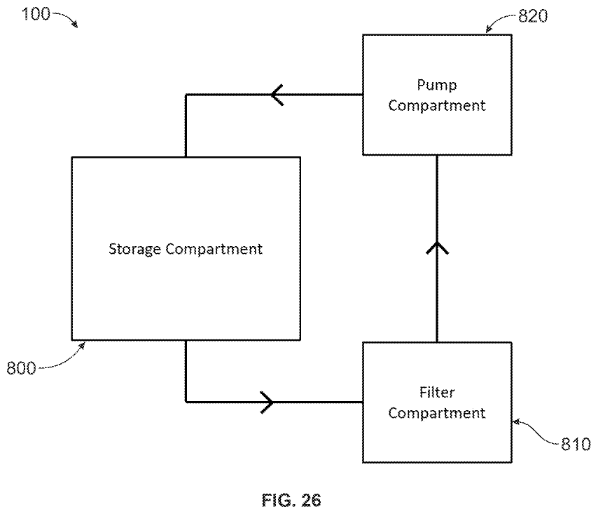

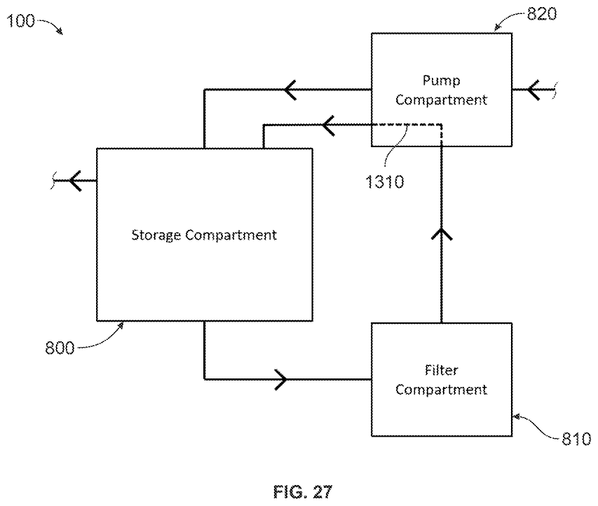

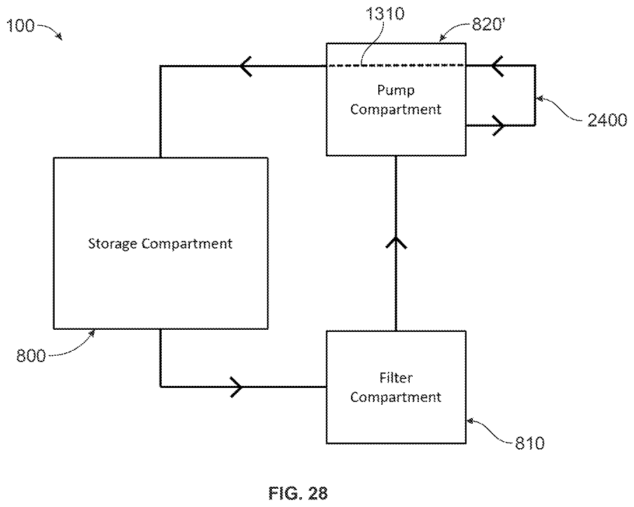

As shown in FIG. 26, in one embodiment, in operation, a liquid, including water, that begins in the pump compartment 820 can be aerated through the use of the venturi pump 1320 and/or the venturi nozzle 1330. The aerated liquid can then pass through the pump filter element 1210 of the pump base 1200 before entering the flow pump intake port 1370 and the flow pump 1340. The flow pump 1340 can then be used to urge the liquid through the discharge hose 1400, to the storage compartment 800. In one embodiment, the liquid can pass through a chilling compartment (not shown) before entering the storage compartment 800.

In the storage compartment, the liquid can then be urged through the ventilation tubes 600 at a desired flow rate. In one embodiment, the storage compartment can comprise at least one pump 620 to urge the liquid through the ventilation tubes 600 at a desired flow rate. The at least one pump 620 can urge the liquid through the ventilation tubes 600 from the bottom of the storage compartment 800, such that the liquid can travel across the ventilation tubes 600 in a laminar flow, starting at the bottom of the ventilation tubes 600 and ending at the top of the ventilation tubes 600. In another embodiment, the liquid can enter the storage compartment 800 at or near the top of the storage compartment 800, and travel to the at least one pump at or near the bottom of the storage compartment 800, before it is urged through the ventilation tubes 600 at a desired flow rate.

After the liquid has been urged through the ventilation tubes 600, it can exit the storage compartment 800, including through an at least one inter-compartment exit port 1010, or other filtered ports, and enter the filter compartment 810. In the filter compartment 810, the liquid can pass through filter element 812, which can comprise a variety of filters, skimmers, oxygen diffusers, venturi pump systems, and other suitable filter means. As the liquid passes through the filter element 812, debris can be prevented from passing through the filter element 812 with the liquid. After the liquid has passed through the filter element 812, it can reenter or return to the pump compartment 820, including through the return hose 1310, and the cycle can begin any. In one embodiment, the return hose 1310 can be coupled and in fluid communication with the fitting 1100, such that the liquid can pass through the fitting 1100 and the return hose 1310 before returning to the pump compartment 820. In another embodiment, the return hose 1310 and the discharge hose 1400 can be in fluid communication with each other and can comprise a closed fluid loop. The above process can be run at a gallon-per-hour rate that corresponds with the gallon-per-hour rating of the flow pump 1340. Further, the above process can be repeated, such that the subject water can be recirculated as many times as necessary.

As shown in FIG. 27, in another embodiment, in operation when a liquid, including water, is cycled through the storage compartment 800, filter compartment 810, and the pump compartment 820, the return hose 1310 can pass through the pump compartment 820 to be in direct fluid communication with the storage compartment 800. In such embodiment, external liquid, including water from an external source (e.g., lake, pond, or other freshwater and saltwater bodies of water) can enter the pump compartment 820 before being aerated. Additionally, as liquid continuously fills the storage compartment 800 during operation, excess liquid can exit the storage compartment 800, including over the top of the modular aeration apparatus 100 when the lid assembly 500 is open, through an overflow port (not shown), or in any other suitable manner. The above process can be run at a gallon-per-hour rate that corresponds with the gallon-per-hour rating of the flow pump 1340. Further, the above process can be repeated, such that the subject water can be recirculated as many times as necessary.

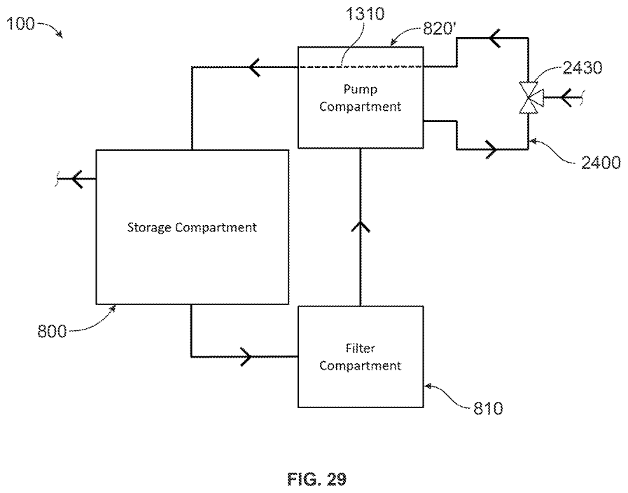

As shown in FIG. 29, in yet another embodiment, in operation, a liquid, including water, that begins in the pump compartment 820′ can be aerated through the use of the venturi pump 1320 and/or the venturi nozzle 1330. The aerated liquid can then pass through the pump filter element 1210 of the pump base 1200 before entering the flow pump intake port 1370 and the flow pump 1340. The flow pump 1340 can then be used to urge the liquid through the discharge hose 1400, to the external circuit of hoses or tubing 2400. In one embodiment, the external circuit of hoses or tubing 2400 can comprise an external discharge hose 2410 and an external return hose 2420. The external discharge hose 2410 and the external return hose 2420 can be in fluid communication with each other and can comprise a closed fluid loop. The liquid can be urged through the external circuit of hoses or tubing 2400 before being urged to the storage compartment 800. In one embodiment, the liquid can pass through a chilling compartment (not shown) before entering the storage compartment 800. In another embodiment, the liquid can pass through a return hose 1310. The return hose 1310 can be coupled and in fluid communication with the pump compartment 800. In another embodiment, the return hose 1310 can pass through the pump compartment 820′ to be in direct fluid communication with the storage compartment 800.

In the storage compartment, the liquid can then be urged through the ventilation tubes 600 at a desired flow rate. In one embodiment, the storage compartment can comprise at least one pump 620 to urge the liquid through the ventilation tubes 600 at a desired flow rate. The at least one pump 620 can urge the liquid through the ventilation tubes 600 from the bottom of the storage compartment 800, such that the liquid can travel across the ventilation tubes 600 in a laminar flow, starting at the bottom of the ventilation tubes 600 and ending at the top of the ventilation tubes 600. In another embodiment, the liquid can enter the storage compartment 800 at or near the top of the storage compartment 800, and travel to the at least one pump at or near the bottom of the storage compartment 800, before it is urged through the ventilation tubes 600 at a desired flow rate.

After the liquid has been urged through the ventilation tubes 600, it can exit the storage compartment 800, including through an at least one inter-compartment exit port 1010, or other filtered ports, and enter the filter compartment 810. In the filter compartment 810, the liquid can pass through filter element 812, which can comprise a variety of filters, skimmers, oxygen diffusers, venturi pump systems, and other suitable filter means. As the liquid passes through the filter element 812, debris can be prevented from passing through the filter element 812 with the liquid. After the liquid has passed through the filter element 812, it can reenter or return to the pump compartment 820′, including through the fitting 1100, such that the liquid can pass through the fitting 1100 before returning to the pump compartment 820′. The above process can be run at a gallon-per-hour rate that corresponds with the gallon-per-hour rating of the flow pump 1340. Further, the above process can be repeated, such that the subject water can be recirculated as many times as necessary.

As shown in FIG. 29, in even yet another embodiment, in operation when a liquid, including water, is cycled through the storage compartment 800, filter compartment 810, and the pump compartment 820′, the external circuit of hoses or tubing 2400 may comprise a t-fitting 2430 in fluid communication with a source-water hose 2440. The t-fitting 2430 can be adapted to selectively add water from an external source (e.g., lake, pond, or freshwater and saltwater bodies of water) to the external circuit of hoses or tubing 2400, before the water contained therein enters the storage compartment 800, the pump compartment 820′, or a chilling compartment. The liquid can be urged through the external circuit of hoses or tubing 2400 before being urged to the storage compartment 800. In one embodiment, the liquid can pass through a chilling compartment before entering the storage compartment 800. In another embodiment, the liquid can pass through a return hose 1310. Additionally, as liquid continuously fills the storage compartment 800 during operation, excess liquid can exit the storage compartment 800, including over the top of the modular aeration apparatus 100′ when the lid assembly 500 is open, through an external overflow port 1700, including via the internal overflow port 2000, or in any other suitable manner. The above process can be run at a gallon-per-hour rate that corresponds with the gallon-per-hour rating of the flow pump 1340. Further, the above process can be repeated, such that the subject water can be recirculated as many times as necessary.

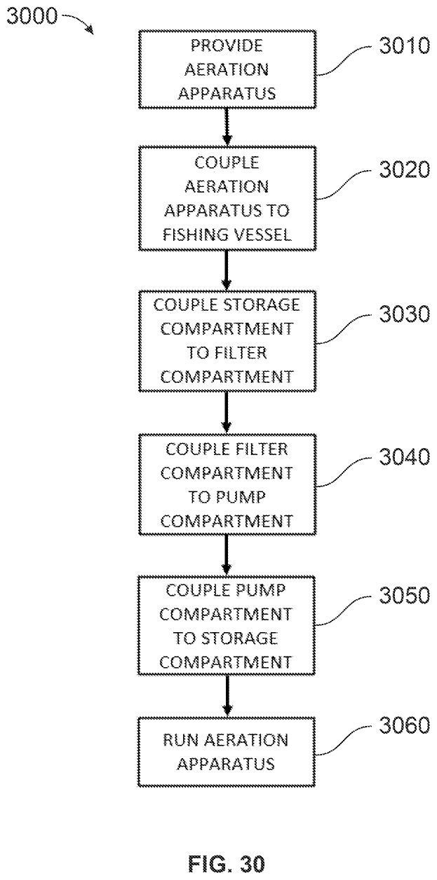

According to exemplary embodiments, a method or process of installing a modular aeration apparatus 100, 100′, of the type presented herein, can also be provided with the present invention. FIG. 30 is a diagram depicting an example method 3000 for installing the modular aeration apparatus 100, 100′. As indicated by block 3010, an modular aeration apparatus 100, 100′ can be provided.

As indicated by block 3020, the modular aeration apparatus 100, 100′ can be coupled with a fishing vessel 2500. In one embodiment, the modular aeration apparatus 100′ can comprise an external circuit of hoses or tubing 2400. The external circuit of hoses or tubing 2400 can comprise a t-fitting 2430, and the t-fitting 2430 can be in fluid communication with a source-water hose 2440. The t-fitting 2430 can be adapted to selectively add water from an external source (e.g., lake, pond, or freshwater and saltwater bodies of water) to the external circuit of hoses or tubing 2400. The source-water hose 2440 may be fluid communication with a freshwater and saltwater body of water in which the fishing vessel 2500 is operated. In another embodiment, the modular aeration apparatus 100, 100′ can be installed in a fishing vessel 2500 during the original manufacture of the boat. In yet another embodiment, the modular aeration apparatus 100, 100′ can be installed in fishing vessel 2500 as a retrofit package.

Block 3030 illustrates how the storage compartment 800 can be coupled with the filter compartment 810. In one embodiment, the storage compartment 800 can be coupled with the filter compartment 810 through at least one inter-compartment exit port 1010.

As shown in Block 3040, the filter compartment can then be coupled with the pump compartment 820, 820′. In one embodiment, the filter compartment can then be coupled with the pump compartment 820, 820′ through a fitting 1100. In another embodiment, the filter compartment can then be coupled with the pump compartment 820, 820′ through a return hose 1310.

Then, as illustrated Block 3050, the pump compartment 820, 820′ can be coupled with the storage compartment 800. By coupling the pump compartment 820, 820′ to the storage compartment 800, the modular aeration apparatus 100, 100′ can comprise a closed fluid loop. In one embodiment, the pump compartment 820, 820′ can be coupled with the storage compartment 800 through a discharge hose 1400. In another embodiment, the modular aeration apparatus 100′ can comprise external circuit of hoses or tubing 2400, pump compartment 820′ can be coupled with the storage compartment 800 via the external circuit of hoses or tubing 2400. The external circuit of hoses or tubing 2400 can comprise an external discharge hose 2410, an external return hose 2420, a t-fitting 2430, and a source-water hose 2440. In yet another embodiment, the modular aeration apparatus 100, 100′ can comprise a chilling compartment. In one embodiment, the chilling compartment can be adapted to chill a liquid passing therethrough. The chilling compartment can be coupled with the storage compartment 800.

As shown in Block 3060, the modular aeration apparatus 100, 100′ can then be run to circulate a liquid, including water, through the storage compartment 800, the filter compartment 810, and the pump compartment 820, 820′. In one embodiment, the modular aeration apparatus 100, 100′ can further comprise an aerating compartment and aerate the liquid. In another embodiment, the modular aeration apparatus 100, 100′ can further comprise a degassing compartment and degas the liquid.

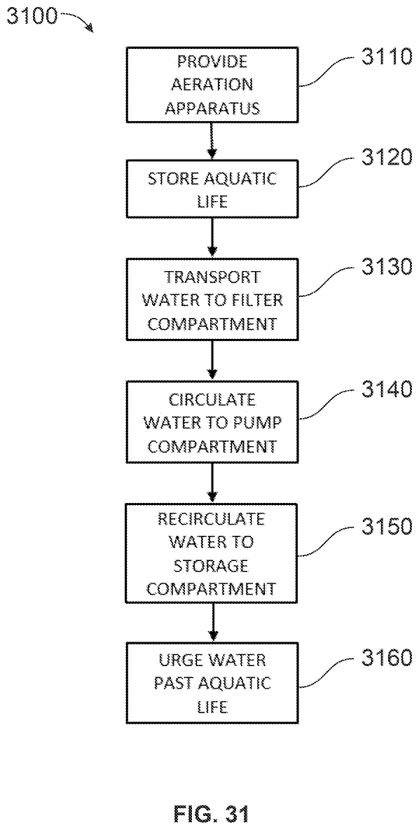

According to exemplary embodiments, a method or process of operating a modular aeration apparatus 100, 100′, of the type presented herein, can also be provided with the present invention. FIG. 31 is a diagram depicting an example method 3100 for operating the modular aeration apparatus 100, 100′. As indicated by block 3110, an modular aeration apparatus 100, 100′ can be provided.

As indicated by block 3120, aquatic life can then be stored in the modular aeration apparatus 100, 100′, including in a storage compartment 800. In one embodiment, the storage compartment 800 can comprise at least one ventilation tube 600. In certain embodiments, the dimensions of the ventilation tubes 600 can be sized to correspond with the size of the desired aquatic life to be stored, sustained, or supported therein. In one embodiment, the ventilation tubes 600 can comprise ram gill ventilation tubes for use with aquatic animals with passive gill ventilation. In another embodiment, the ventilation tubes 600 can comprise soft, flexible materials designed for use with aquatic animals with passive gill ventilation.

As shown in block 3130, water can begin in the storage compartment 800 and be transported to the filter compartment 810. In the filter compartment 810, the water can be filtered through the filter element 812, which can comprise a variety of filters, skimmers, oxygen diffusers, venturi pump systems, and other suitable filter means. As the water passes through the filter element 812, debris can be prevented from passing through the filter element 812 with the water.

Then, as shown in block 3140, after the water has passed through the filter compartment 810, water can then be circulated to the pump compartment 820, 820′. In one embodiment, the pump compartment 820, 820′ can comprise an aerating compartment to aerate the water. The aerating compartment can comprise a venturi pump 1320 and/or the venturi nozzle 1330. The venturi pump 1330 can collect and urge air through the venturi nozzle 1320, including air provided by a venturi air intake hose 1360 coupled and in fluid communication with the venturi air intake port 200. The flow of liquid or gas through the venturi nozzle 1320 can create bubbles in the water.

In another embodiment, a pump compartment 820, 820′ can comprise a degassing compartment. In one embodiment, the modular aeration apparatus 100, 100′ can allow pressurized air or gas to exit a degassing compartment based on predetermined pressure levels or pressure differentials. In another embodiment, a degassing vent 210 can allow pressurized air, which may accumulate from the use of the venturi nozzle 1320 and/or venturi pump 1330, and the bubbles created thereby, to selectively exit the pump compartment 820, 820′, as the degassing compartment, in a one-way manner.

Then, as illustrated in block 3150, the water can be recirculated to the storage compartment 800. In one embodiment, the water can pass through a chilling compartment and be chilled therein before being recirculated to the storage compartment 800.

Finally, as shown in block 3160, the water can then be urged water past the aquatic life. In one embodiment, the water can be urged through ventilation tubes 600 at a desired flow rate. In one embodiment, at least one pump 620 can be used to urge water through ventilation tubes 600 at a desired flow rate. In another embodiment, the at least one pump 620 can urge the liquid through the ventilation tubes 600 from the bottom of the storage compartment 800, such that the liquid can travel across the ventilation tubes 600 in a laminar flow, starting at the bottom of the ventilation tubes 600 and ending at the top of the ventilation tubes 600.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention.

What is claimed is:

1. A modular aeration apparatus, comprising:
a storage compartment;
a filter compartment coupled with the storage compartment and comprising a filter element; and
a pump compartment coupled with the storage compartment and comprising a venturi air intake port, a degassing vent, a pump filter element, and a pump assembly;
wherein:
the pump assembly comprises a venturi nozzle coupled with the venturi air intake port and a flow pump in fluid communication with a flow pump intake port; and
the pump filter element at least partially encircles the flow pump intake port.

2. The modular aeration apparatus of claim 1, wherein the storage compartment comprises a plurality of ventilation tubes.

3. The modular aeration apparatus of claim 2, wherein the storage compartment further comprises at least one pump for urging water through the plurality of ventilation tubes.

4. The modular aeration apparatus of claim 1, wherein the filter compartment is coupled with the pump compartment.

5. The modular aeration apparatus of claim 1 further comprising a chilling compartment coupled with the storage compartment.

6. The modular aeration apparatus of claim 1, wherein the pump compartment comprises:
a discharge hose coupled with the flow pump;
an internal discharge port in fluid communication with the discharge hose;
a return hose;
an internal return port in fluid communication with the return hose; and
an external circuit of hoses in fluid communication with the internal discharge port and the internal return port.

7. The modular aeration apparatus of claim 6, wherein the external circuit of hoses comprises an external discharge hose and an external return hose.

8. The modular aeration apparatus of claim 7, wherein:
the external circuit of hoses further comprises a t-fitting in fluid communication with the external discharge hose and the external return hose; and
a source-water hose in fluid communication with the t-fitting.

9. The modular aeration apparatus of claim 8, wherein the t-fitting comprises a flow restrictor.

10. The modular aeration apparatus of claim 1, wherein the storage compartment comprises an internal overflow port.

11. A system for aerating circulated water, comprising:
a storage compartment; and
at least one aeration apparatus comprising:
a filter compartment coupled with the storage compartment and comprising a filter element; and
a pump compartment coupled with the storage compartment and comprising a venturi air intake port, a degassing vent, a pump filter element, and a pump assembly;
wherein:
the pump assembly comprises a venturi nozzle coupled with the venturi air intake port and a flow pump in fluid communication with a flow pump intake port;
the pump filter element at least partially encircles the flow pump intake port.

12. The system of claim 11, wherein the storage compartment comprises a plurality of ventilation tubes.

13. The system of claim 12, wherein the storage compartment further comprises at least one pump for urging water through the plurality of ventilation tubes.

14. The system of claim 11 further comprising a chilling compartment coupled with the storage compartment.

15. The system of claim 11, wherein the pump compartment comprises:
a discharge hose coupled with the flow pump;
an internal discharge port in fluid communication with the discharge hose;
a return hose;
an internal return port in fluid communication with the return hose; and
an external circuit of hoses in fluid communication with the internal discharge port and the internal return port.

16. The system of claim 15, wherein the external circuit of hoses comprises an external discharge hose and an external return hose.

17. The system of claim 16, wherein:
the external circuit of hoses further comprises a t-fitting in fluid communication with the external discharge hose and the external return hose; and
a source-water hose in fluid communication with the t-fitting.

18. The system of claim 17, wherein the t-fitting comprises a flow restrictor.

19. A method for operating a modular aeration apparatus, the method comprising the steps of:
providing a modular aeration apparatus, comprising:
a storage compartment;
a filter compartment comprising a filter element; and
a pump compartment comprising a venturi air intake port, a degassing vent, a pump filter element, and a pump assembly;
storing at least one aquatic life in the storage compartment;
transporting water to the filter compartment;
circulating water to the pump compartment;
recirculating water to the storage compartment; and
urging water past the at least one aquatic life;
wherein:
the pump assembly comprises a venturi nozzle coupled with the venturi air intake port and a flow pump in fluid communication with a flow pump intake port; and
the pump filter element at least partially encircles the flow pump intake port.

20. The method of claim 19, wherein the pump compartment comprises:
a discharge hose coupled with the flow pump;
an internal discharge port in fluid communication with the discharge hose;
a return hose;
an internal return port in fluid communication with the return hose; and
an external circuit of hoses in fluid communication with the internal discharge port and the internal return port.
